(19) United States
(12) Patent Application Publication
(10) Pub. No.: US 2006/0045570 A1
(43) Pub. Date: Mar. 2, 2006

(54) Belt unit, image forming apparatus using the belt unit

(76) Inventors: Tsutomu Kato, Kawasaki-shi (JP); Mitsuru Takahashi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/217,404

(22) Filed: Sep. 2, 2005

(30) Foreign Application Priority Data
Sep. 2, 2004 (JP) 2004-255723

(51) Int. Cl. G03G 15/16

(52) U.S. Cl. 399/121

(57) ABSTRACT

A belt unit attachable and detachable from an image forming apparatus and having stable belt running characteristics. The belt unit includes a belt, at least two support rollers and a front frame. The frame has at least one standard portion to position the unit with respect to the main body of the image forming apparatus. At least one of the standard portions in the front frame is disposed in a vertical direction to a standard portion of a rear side.

### CROSS-REFERENCE TO RELATED APPLICATION

This document claims priority and contains subject matter related to Japanese Patent Applications No. 2004-255723, filed on Sep. 02, 2004, which is incorporated herein by reference.

### BACKGROUND OF THE INVENTION

1. Field of the Invention

The present invention relates to a belt unit. In addition, the present invention also relates to an image forming apparatus such as a copier, a laser beam printer, an ink jet printer, an LED printer and a facsimile using the belt unit.

2. Discussion of the Background

In an image forming apparatus, it is necessary to increase the carrying speed of transfer paper in order to increase output. For this reason, it is important to use a belt unit that has high running stability. In addition, more and more users have been using a full color printing function of an image forming apparatus, and they have been demanding an image forming apparatus capable of conducting full color imaging processes in substantially the same time required for monochrome imaging processes. Accordingly, an image forming apparatus of a tandem-type having a plurality of photoconductive members has been developed to decrease the process time required for full color imaging processes.

Belt units have been adopted in such tandem-type image forming apparatuses. However, the belts of these belt units deteriorate over time. In the case of transfer belts, belt deterioration causes a reduction in image quality, and therefore, it is necessary to change the unit periodically. Conventionally, the user who has technical knowledge or a serviceman performed the exchange of a belt unit. And a high strength frame, such as a plate-metal or a push-out material of aluminum, was adopted as the unit frame. Recently, the belt units in image forming apparatuses have become exchangeable so that the general users are able to exchange the unit. To deal with such a tendency, belt units have been formed using resin as the frame to produce a lightweight unit and lower manufacturing cost.

However, it is difficult to increase the thickness of the frame because of the use of the tandem method and miniaturization of the unit. As a result, the hardness of unit tends to be weak. Due to this tendency, the belt unit frame can bend easily. As a result, belt run characteristics become unstable, and a problem can occur in which the belt can contact a unit member.

Japanese Patent Laid-Open No. 5-66683 describes an image forming apparatus, in which transferring materials are supplied with a transportation belt to an image transferring portion formed between an image bearing member and a transferring member. After an image is transferred, the materials are supplied by the transportation belt to a nip portion of a fuser roller pair in a fixation portion. In this related art, a blocking member, which blocks a bend in the belt, is placed on the back side surface of the belt between the transferring portion and the fixation portion to prevent deterioration of image quality induced by transferring dislocation due to the bend in the transportation belt caused by shock of penetrating of the transferring materials into the fixation portion. By means of the blocking member, the transferring dislocation that is induced by penetrating of the transferring materials into the fixation portion is prevented.

In addition, Japanese Patent Laid-Open No. 2000-147951 describes an image forming apparatus that has an image bearing means bearing a toner image electrostatically by charging exposing, and a recording material transportation means with a dielectric sheet transporting the recording material, a transferring means transferring the toner image from the image bearing means to the recording material on the transportation means, and a bend quantity adjusting means adjusting the bend quantity of the transportation means.

The bend quantity adjusting means lowers a charge density on the image bearing member in the absence of the record material between the image bearing member and the record material transportation means to a level lower than that in the presence of the record material by the charging or exposing. By means of the adjusting means, the bend quantity of the record material transporting means is decreased below a normal level, and a color offset, an error of correction using an automatic registration adjustment mechanism, and an irregularity in light and shade in the image is prevented.

However, because the related art in Japanese Patent Laid-Open No. 5-66683 needs an additional member to block the bend, inefficient work is induced, and there is the risk of unfastening of the additional member. In addition, the object of the related art in Japanese Patent Laid-Open No. 2000-147951 concerns an electrostatic bend of a belt, and does not concern cancellation of a physical bend of belt unit itself.

In addition, because of the increased need for a general user to exchange the belt unit, it is preferable that the belt unit can be attachable and detachable in a direction parallel to the record material transporting surface, since this direction usually corresponds to the front of the image forming apparatus, and the work efficiency is increased.

However, in such a configuration, the image forming apparatus does not have a board supporting one end of the support rollers of the belt unit at the front side of the image forming apparatus. Therefore, the transfer belt unit may not be accurately positioned in the image forming apparatus.

In view of such a drawback, it is possible to fix the position of the transfer belt unit by using other parts such as fixing plates, however such a configuration decreases work efficiency by adding attachment and detachment work of the fixing plates. In addition, since the fixing plates need to be rigid and accurate, this results in increase in manufacturing cost.

### SUMMARY OF THE INVENTION

It is a general object of the present invention to provide a belt unit in which one or more of the above-mentioned problems are eliminated.

A first object of the present invention is to provide an improved belt unit that can be easily attached and detached by a user from an image forming apparatus.

A second object of the present invention is to provide an improved belt unit having a belt having stable running characteristics that have less bend and torsion.

A third object of the present invention is to provide an image forming apparatus that includes the belt unit.

In order to achieve the above-mentioned object, there is provided according to one aspect of the present invention a belt unit configured to be detachable from an image forming apparatus, including a belt, at least two support rollers supporting the belt, a front frame containing the support rollers. The frame has at least one standard portion to position the unit itself to the main body of image forming apparatus, and at least one standard portion in the front frame that is disposed in a vertical direction to a standard portion of a rear side.

Additionally, there is provided according to another aspect of the invention an image forming apparatus including the above-mentioned belt unit.

Other objects, features and advantages of the present invention will become more apparent from the following detailed description when read in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an exemplary structure of an image forming apparatus according to an embodiment of the present invention when the belt unit is attached;

FIG. 2 shows an exemplary structure of an image forming apparatus according to an embodiment of the present invention when the belt unit is detached;

FIG. 3 is an enlarged view showing an inside of a belt unit;

FIG. 4 is a perspective view showing a top side of a belt unit;

FIG. 5 is a perspective view showing a top side of a belt unit when the belt is detached;

FIG. 6 shows a configuration in which a holding member 56 is attached to front frame 48 of belt unit 40;

FIG. 7 is an enlarged view of the front frame 48; and

FIG.. 8 shows an exemplary structure of an image forming apparatus according to another embodiment of the present invention.

### DETAILED DESCRIPTION OF THE PREFERRED EMBODIMENTS

The best mode for carrying out the invention is explained below with reference to the figures. The present invention is not limited to the specifically disclosed embodiments, and variations and modifications may be made without departing from the scope of the present invention.

Reference will now be made in detail to the present preferred embodiments of the invention, examples of which are illustrated in the accompanying drawings. Wherever possible, the same reference numbers are used in the drawings and the description to refer to the same or like parts.

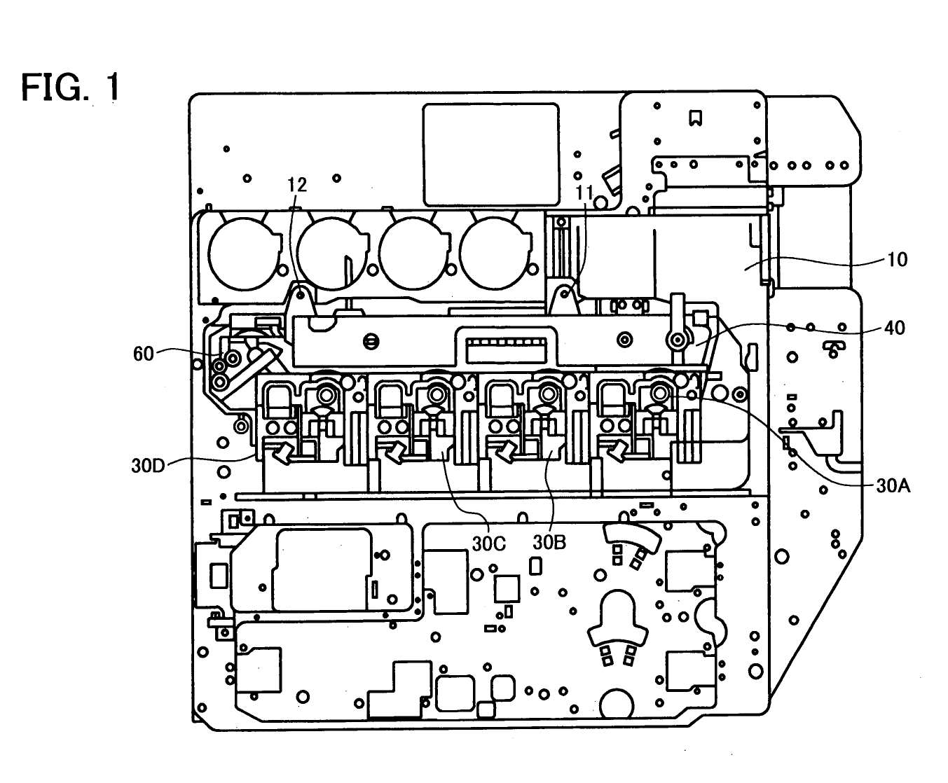

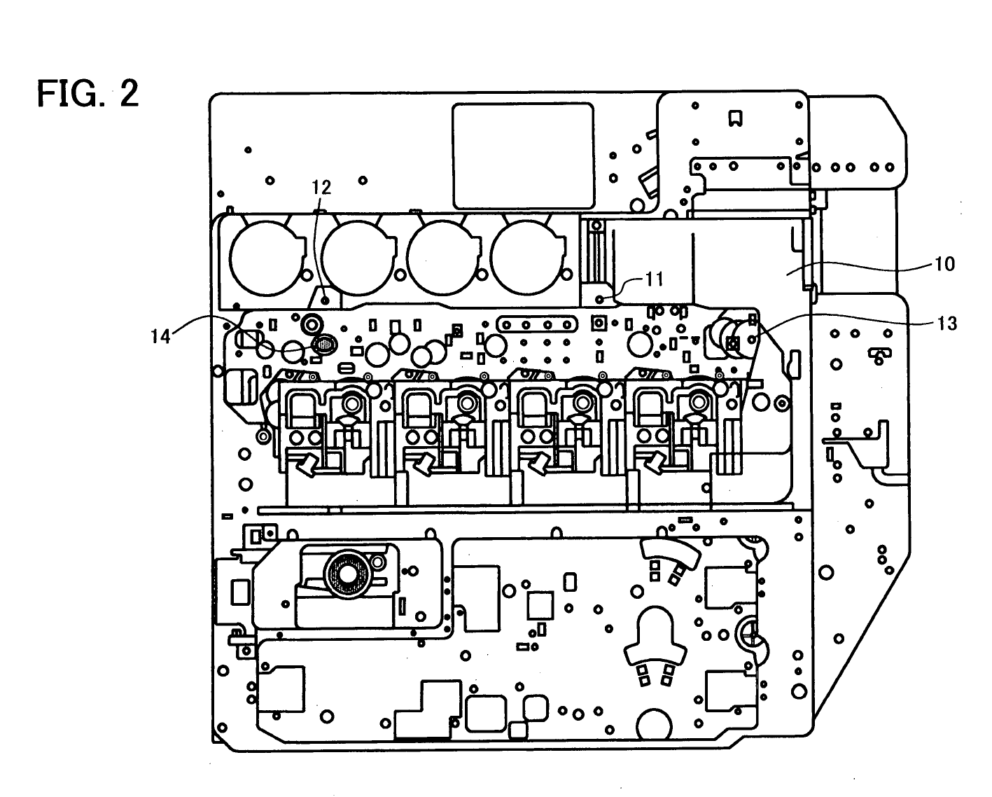

FIGS. 1 and 2 show an outline of the structure of a front side plate and a rear side plate of an image forming apparatus as one embodiment of the present invention. Image forming device 10 has structures that can detachably hold the belt unit 40. More specifically, the image forming device 10 holds the belt unit 40 in a direction parallel to the transferring material conveying surface so that even a public user can easily perform an exchange of the belt unit.

In addition, the image forming apparatus has the belt unit as an intermediate transfer belt unit that transfers an image, which is transferred from the photoconducters that are disposed along the belt surface, onto a transferring material that is supplied to an outer surface of the belt unit.

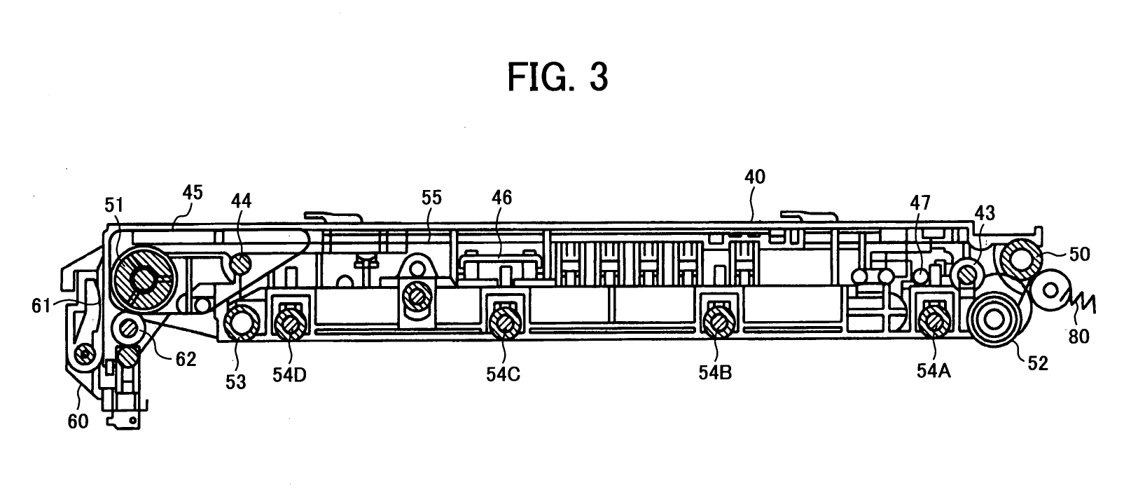

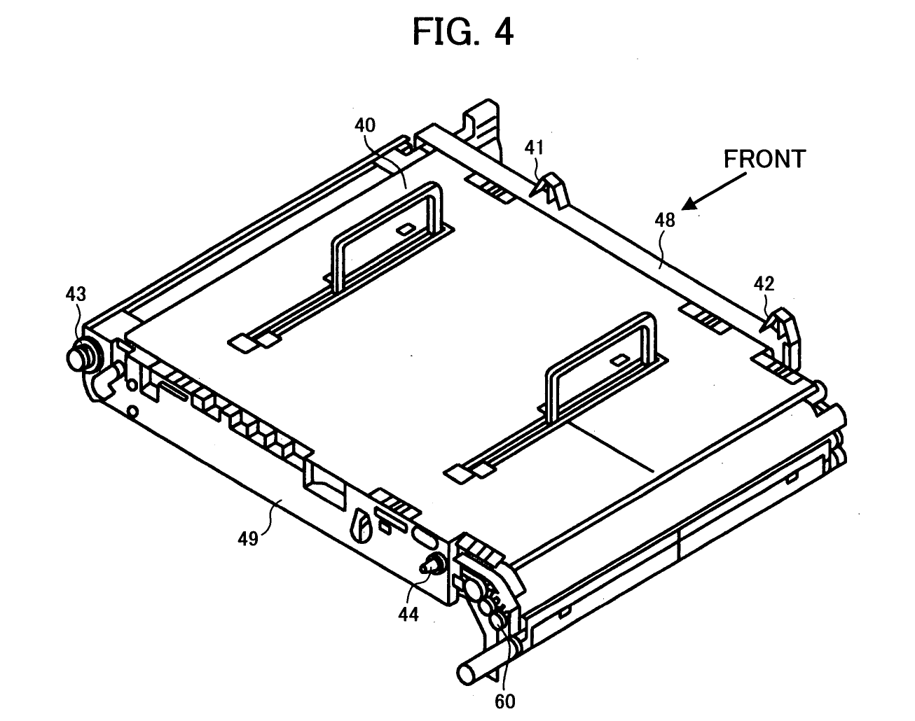

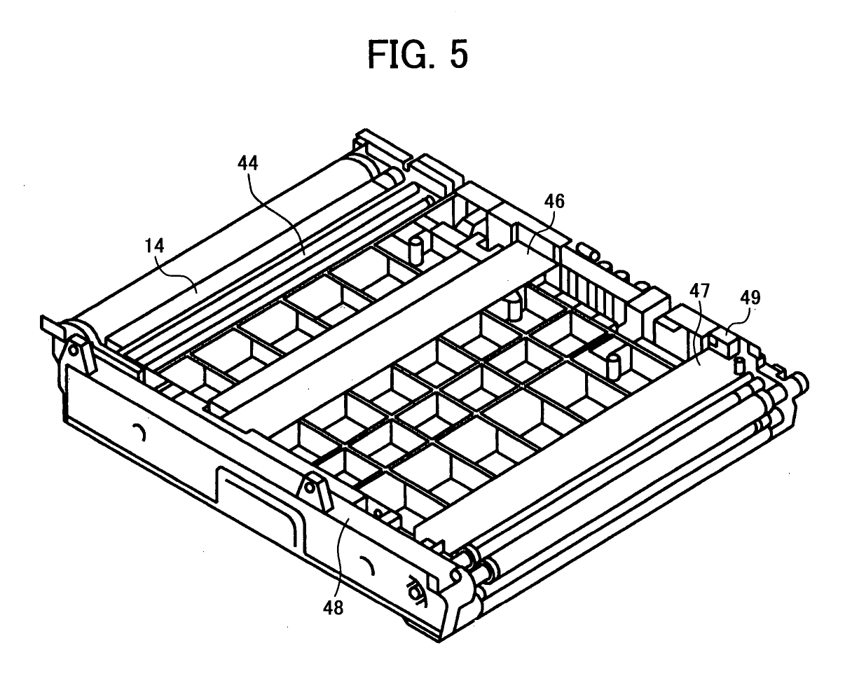

FIG. 3 is an enlarged view showing an inside of the belt unit 40. In addition, FIG. 4 is a perspective view showing a top side of the belt unit. FIG. 5 is a perspective view showing a top side of the belt unit when the belt is detached. Belt unit 40 comprises belt 55, drive roller 50, tension roller 51, entrance roller 52, and back up roller 53, where each roller is held by front frame 48 and rear frame 49. In addition, the front frame 48 and the rear frame 49 are connected by stays 46, 47.

When the belt unit 40 is installed to image forming apparatus 10, bearing 43 holding drive roller 50 in the rear belt unit is held by means of drive motor bracket 13 of the main body of image forming apparatus 10. In addition, standard shaft 44 is held by standard hole 14 of the rear side plate of image forming apparatus 10. On the other hand, in front of belt unit side, standard holes 41,42 of an entrance frame are held by standard shaft 11,12 of the main body of image forming apparatus 10, respectively (see FIGS. 1 and 2). The standard shaft and the standard hole are disposed to position the belt unit to the main body of image forming apparatus. The present embodiment is constructed so that standard shaft 44 (14) of the rear side plate and standard hole 42 (12) of the front side plate are perpendicularly aligned as viewed from the front.

As thus described, the present embodiment has a standard portion for attaching the belt unit to the image forming apparatus in the belt unit itself, and therefore, the attachment of the belt unit to the image forming apparatus in the horizontal direction is stable. Moreover, by disposing the front standard and the rear standard perpendicularly, the belt unit is installed to the main body of image forming apparatus stably without a degree of leaning as against the main body.

With this embodiment, since the forces that influences bending of the unit are decreased, stable belt run characteristics are realized and the possibility of the belt running into a unit member is prevented.

In addition, in the present embodiment, the front standard is disposed at a higher position than the rear standard, however, in other embodiments of the image forming apparatus of the present invention, a reversed constitution can be adopted. In addition, in this example, standard shaft 44 of the belt unit is provided as a member making one standard of the rear side.

As thus described, the shaft that is supported by the front frame 48 and the rear frame 49, is adopted as a standard member, therefore, the position of the front and rear frame is regulated. As a result, the bending of the frame and the twisting of the front frame and the rear frame is decreased, and stability of the belt run characteristics is realized. In addition, adding a reinforcing rib can reinforce the standard hole 42 of the front frame and a holding portion of standard shaft 44.

Still further, in the example, the standard shaft 44 of the belt unit is held to driven bracket 45, which holds tension roller 51 (FIG. 3 and cf. FIG. 5). When the belt 55 is detached from the belt unit 40, the driven bracket 45 is rotated around the standard shaft 44. In the present embodiment, the front frame 48 and the rear frame 49 through the standard shaft 44 support the weight of the driven bracket 45. Therefore, the weight of the driven bracket 45 is loaded on standard 42 (12) in the vertical direction. As thus described, the image forming apparatus, which installs the belt unit of the present embodiment therein, is capable of lowering influences such as frame bending due to the weight of members comprising the belt unit such as driven bracket 45.

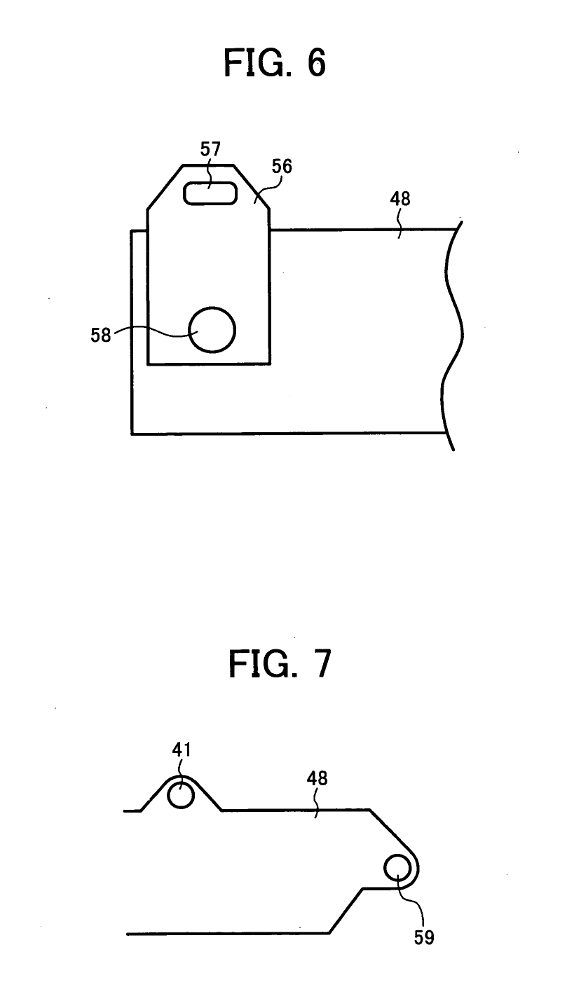

Now, when there is not enough strength between standard hole 42 of the front frame and the support member of standard shaft 44, the front frame can bend under the weight of unit itself. Thus, when a thick member or a reinforced shape member is not provided between the standard hole 42 and the support members of the standard shaft 44, it is possible to prevent bending of the front frame by providing a strong hold member for the front frame with a standard hole instead of using standard hole 42. FIG. 6 shows a hold member 56 that is attached to the front frame 48 of the belt unit 40 of the present embodiment.

A standard hole 57 installed in hold member 56 receives the standard shaft 12 of the front frame of the main body, and a support hole 58, which is disposed lower than the standard hole 57, holds the standard shaft 44. As thus described, when a reinforced member is not provided for the support portion of the front frame, which receives the standard shaft 12 of the main body, the bending of the front frame is prevented by providing a strong hold member 56 for the belt unit 40 accurately. This embodiment realizes a lightweight and low cost belt unit as compared to conventional configurations provided with a fixing plate separately from the front frame.

Still further, transfer roller 80, which is used for transferring an image to transferring materials, is in contact with a belt drive roller 50. Concerning the contact between the roller 80 and roller 50, the contact pressure between these rollers is small so that bearing 43 of drive roller 50 is held in close to the contact position at the rear side of belt unit 40. But at the front side of belt unit 40, when the contact pressure of transfer roller 80 is strong, because the standard 41 is disposed apart from the drive roller 50 due to the arrangement, the front frame can be bent by pressure.

Thus, with this present embodiment, a new standard is added to the portion close to the contact position of the transfer roller 50 at the front frame 48 in order to prevent influence of contact pressure of an opposed roller.

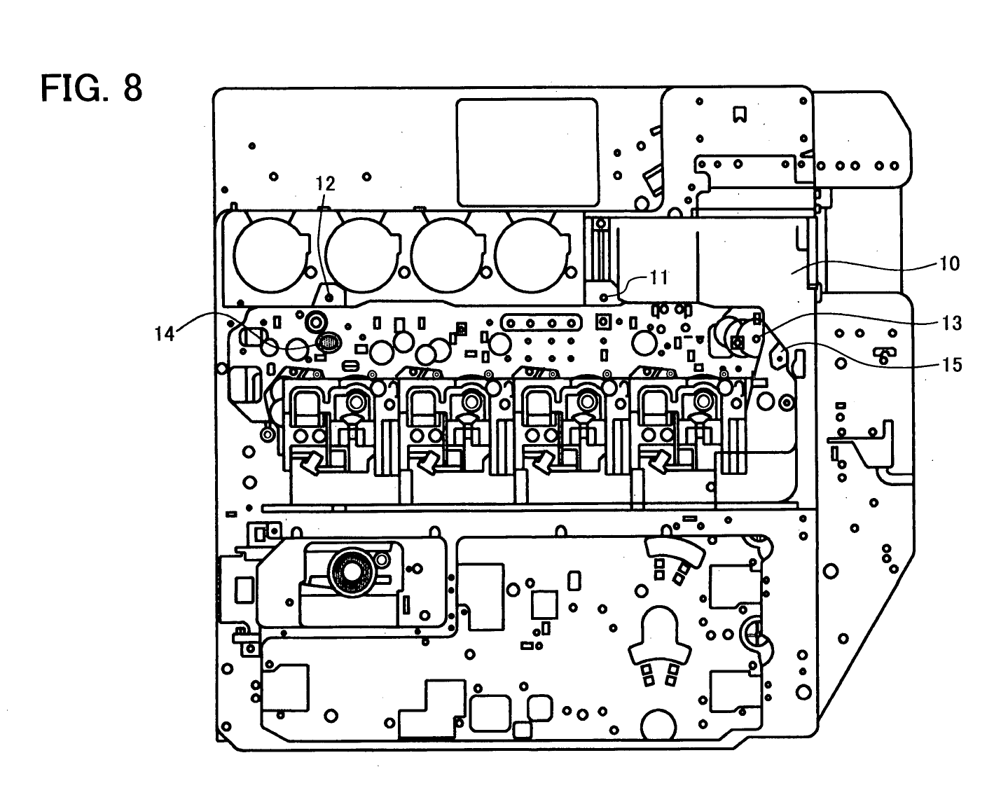

FIG. 7 shows an enlarged view of the portion of the front frame 48 close to the contact position of the transfer roller 80 and the front frame 48. In addition to the above-mentioned standard 41, a new standard 59 is added and held by standard 15 as shown in FIG. 8, in order to prevent the influence of contact pressure of an opposed roller. In this embodiment, as the influence by pressure of the contact member becomes small, the bending of the frame is prevented, and stable image forming is realized.

In this embodiment, the image forming apparatus has the belt unit as an intermediate transfer belt unit, which transfers an image, which is transferred from the photoconducters disposed along the belt surface, onto a transferring material that is supplied to the outer-surface of the belt unit. But it is possible to adopt the belt unit 40 as transferring transportation belt unit, which transports the transcription material and transfers an image from an image bearing means to the transcription material thereon. By this, as the flexure of the transferring transportation belt unit is eliminated, the transportation of the transcription material is stable due to the stabilization of the belt run, and a deterioration of image quality is decreased.

Still further, it is possible to adopt the belt unit 40 as a transportation belt unit for an ink jet printer, which transports printing material that is printed by ink injected from an ink jet head thereon. By this, as the flexure of transportation belt unit for the ink jet printer is eliminated, the transportation of the printing material is stable due to the stabilization of the belt run, and a high-resolution image can be obtained.

1. A belt unit comprising:
a belt;
at least two support rollers supporting the belt;
a first frame containing the support rollers, the first frame having a first mounting portion that is configured to position the unit with respect to a main body of an image forming apparatus; and
a second frame containing the support rollers, the second frame having a second mounting portion that is configured to position the unit with respect to the main body of the image forming apparatus,
wherein the belt unit has an operational position in which the first mounting portion is disposed vertically above the second mounting portion.

2. The belt unit as claimed in claim 1, wherein the second mounting portion comprises a mounting member, which is supported by the first frame and the second frame.

3. The belt unit as claimed in claim 2, wherein the mounting member is a shaft.

4. The belt unit as claimed in claim 2, wherein the mounting member supports a belt holding member holding the belt.

5. The belt unit as claimed in claim 4, wherein the belt holding member is a bracket holding a tension roller.

6. The belt unit as claimed in claim 2, further comprising a hold member that is configured to directly connect the mounting member and a mounting portion of the main body of the image forming apparatus.

7. The belt unit as claimed in claim 1, further comprising an additional mounting portion on a contacting side of the first frame, wherein the contacting side is configured to contact a pressing member.

8. The belt unit as claimed in claim 7, wherein the contacting side is configured to contact the pressing member, which is a transfer roller.

9. The belt unit as claimed in claim 1, wherein the operational position of the belt unit is configured to be in a substantially horizontal orientation.

10. The belt unit as claimed in claim 1, wherein the first frame and the second frame are configured to be in substantially the same orientation and substantially the same elevation when the belt unit is in the operational position.

11. A belt unit comprising:
a belt;
at least two support rollers supporting the belt;
a first frame containing the support rollers, the first frame having a first mounting portion that is configured to position the unit with respect to a main body of an image forming apparatus; and
a second frame containing the support rollers, the second frame having a second mounting portion that is configured to position the unit with respect to the main body of the image forming apparatus,
wherein the first mounting portion and the second mounting portion are disposed in a same plane that is substantially perpendicular to a longitudinal plane of the belt unit.

12. An image forming apparatus comprising:
a main body;
an image support body provided within the main body and configured to support a latent image;
a developing part provided within the main body and configured to make the latent image visible by supplying toner particles to the latent image formed on a surface of the image support body; and
a belt unit detachably mounted within the main body, wherein the belt unit comprising:
a belt;
at least two support rollers supporting the belt;
a first frame containing the support rollers, the first frame having a first mounting portion that positions the unit with respect to the main body; and
a second frame containing the support rollers, the second frame having a second mounting portion that positions the unit with respect to the main body,
wherein the first mounting portion is disposed vertically above the second mounting portion.

13. The image forming apparatus as claimed in claim 12, wherein the belt unit is an intermediate transfer belt unit, which is configured to transfer a developed image from the image support body disposed along a surface of the belt onto a transferring material supplied to an outer surface of the belt unit.

14. The image forming apparatus as claimed in claim 12, wherein the belt unit is a transferring transportation belt unit, which is configured to transport a transcription material and is configured to transfer the developed image from an image support body to the transcription material.

15. The image forming apparatus as claimed in claim 12, wherein the belt unit is provided in a substantially horizontal orientation.

16. The image forming apparatus as claimed in claim 12, wherein the first frame and the second frame are configured to be in substantially the same orientation and substantially the same elevation.

17. An image forming apparatus comprising:
a main body;
an ink jet head provided within the main body and configured to inject ink to a print material in order to make an image; and
a belt unit detachably mounted within the main body, wherein the belt unit comprises:
a belt;
at least two support rollers supporting the belt;
a first frame containing the support rollers, the first frame having a first mounting portion that positions the unit with respect to the main body; and
a second frame containing the support rollers, the second frame having a second mounting portion that positions the unit with respect to the main body,
wherein the first mounting portion is disposed vertically above the second mounting portion.

18. The image forming apparatus as claimed in claim 17, wherein the belt unit is provided in a substantially horizontal orientation.

19. The image forming apparatus as claimed in claim 17, wherein the first frame and the second frame are configured to be in substantially the same orientation and substantially the same elevation.

20. A belt unit comprising:
a belt;
support means for supporting the belt; and
a frame means for containing the support means, the frame means having a first mounting means for positioning the unit with respect to a main body of an image forming apparatus, and the frame means having a second mounting means for positioning the unit with respect to the main body of the image forming apparatus,
wherein the first mounting means is disposed vertically above the second mounting means.

21. An image forming apparatus comprising:
a main body;
image support means for supporting a latent image;
means for making the latent image visible by supplying toner particles to the latent image formed on a surface of the image support means; and
a belt unit detachably mounted within the main body, wherein the belt unit comprises:
a belt;
support means for supporting the belt; and
a frame means for containing the support means, the frame means having a first mounting means for positioning the unit with respect to the main body, and the frame means having a second mounting means for positioning the unit with respect to the main body,
wherein the first mounting means is disposed vertically above the second mounting means.

22. A method of attaching a belt unit to a main body of an image forming apparatus in a detachable manner, the belt unit includes a belt, at least two support rollers supporting the belt, a first frame containing the support rollers, and a second frame containing the support rollers, the first frame has a first mounting portion that is configured to position the unit with respect to the main body, the second frame has a second mounting portion that is configured to position the unit with respect to the main body, and the belt unit has an operational position in which the first mounting portion is disposed vertically above the second mounting portion, the method comprising:
inserting the belt unit in the main body;
positioning the belt unit in the main body in the operational position; and
locking the belt unit to the main body.

23. The method of attaching the belt unit as claimed in claim 22, wherein the second mounting portion comprises a mounting member, which is supported by the first frame and the second frame.

24. The method of attaching the belt unit as claimed in claim 23, wherein the mounting member is a shaft.

25. The method of attaching the belt unit as claimed in claim 23, wherein the mounting member supports a belt holding member holding the belt.

26. The method of attaching the belt unit as claimed in claim 25, wherein the belt holding member is a bracket holding a tension roller.

27. The method of attaching the belt unit as claimed in claim 23, further comprising a hold member that is configured to directly connect the mounting member and a mounting portion of the main body of the image forming apparatus.

28. The method of attaching the belt unit as claimed in claim 22, further comprising an additional mounting portion on a contacting side of the first frame, wherein the contacting side is configured to contact a pressing member.

29. The method of attaching the belt unit as claimed in claim 28, wherein the contacting side is configured to contact the pressing member, which is a transfer roller.

30. The method of attaching the belt unit as claimed in claim 22, wherein the belt unit is provided in a substantially horizontal orientation in the operational position.

31. The method of attaching the belt unit as claimed in claim 22, wherein the first frame and the second frame are in substantially the same orientation and substantially the same elevation in the operational position.
